(19) United States
(12) Patent Application Publication
(10) Pub. No.: US 2026/0045686 A1
(43) Pub. Date: Feb. 12, 2026

(54) THREE-SECTOR BASE STATION ANTENNA

(71) Applicant: OUTDOOR WIRELESS NETWORKS LLC, Richardson, TX (US)

(72) Inventors: Maosheng Liu, Suzhou (CN); Fei Li, Suzhou (CN); PuLiang Tang, Suzhou (CN); Hangsheng Wen, Suzhou (CN); Ligang Wu, Suzhou (CN)

(21) Appl. No.: 19/263,939

(22) Filed: Jul. 9, 2025

(30) Foreign Application Priority Data
Aug. 9, 2024 (CN) 202411097077.5

(51) Int. Cl. H01Q 3/12; H01Q 1/24; H01Q 21/20

(52) U.S. Cl. CPC H01Q 3/12; H01Q 1/246; H01Q 21/205

(57) ABSTRACT

The present disclosure relates to a three-sector base station antenna. The antenna includes three reflector assemblies in a triangular arrangement. Each reflector assembly includes a back plate, an array of radiating elements mounted on a first face of the back plate facing outwards, and a first phase shifter assembly mounted on a second face opposite to the first face of the back plate facing inwards. The back plate of each reflector assembly has a first central axis equally dividing a width of the back plate, and a first phase shifter assembly of each reflector assembly has a second central axis equally dividing a width of the first phase shifter assembly. The second central axis is offset from the first central axis by a predetermined distance.

### CROSS-REFERENCE TO RELATED APPLICATIONS

This application claims priority to and the benefit of Chinese Patent Application for Invention No. 202411097077.5, filed on Aug. 9, 2024, the disclosures of which are incorporated herein by reference in their entirety.

### FIELD

The present disclosure generally relates to the technical field of wireless communication. More particularly, the present disclosure relates to a three-sector base station antenna.

### BACKGROUND

A cellular communication system is used to provide wireless communication to stationary and mobile users. The cellular communication system may include a plurality of base stations, and each base station provides a wireless cellular service for a designated coverage area (generally referred to as a “cell”). Each base station may include one or more base station antennas, and the base station antenna is used to transmit radio frequency (“RF”) signals to a user located in a cell served by the base station and receive RF signals from the user. The base station antenna is a directional device that can converge RF energy transmitted in certain directions or received from certain directions. A “gain” of a base station antenna in a given direction is a measure of the ability of the antenna to converge RF energy in that direction. A “radiation pattern” of a base station antenna (also referred to as an “antenna beam”) is the compilation of the gain of the antenna in all different directions. Each antenna beam can be designed to serve a predetermined coverage area, for example, a cell or a part of a cell (referred to as a “sector”). The base station antenna usually include linear arrays of radiating elements (for example, patches, dipoles, or crossed dipole radiating elements), and each linear array generates its own antenna beam.

Most prior art base station antennas are configured to be capable of electronically changing the elevation or “tilt” angle of the antenna beam generated by the antenna, and this can be realized by a phase shifter. A widely used phase shifter is a brush-type phase shifter, which includes a main printed circuit board and a sliding piece that can rotate above the main printed circuit board. The brush type phase shifter usually divides an input RF signal received at the main printed circuit board into a plurality of sub-components, and then couples at least some of the sub-components to the sliding piece. The sub-components of the RF signal can be coupled from the sliding piece back to the main printed circuit board along a plurality of arc-shaped tracks (where each arc has a different diameter). Each end portion of each arc-shaped track may be connected to each subgroup of radiating elements including at least one radiating element. By physically (mechanically) rotating the sliding piece above the main printed circuit board, it is possible to change the positions where the sub-components of the RF signal are coupled back to the main printed circuit board, thereby changing the lengths of transmission paths from the phase shifter to each sub-group of radiating elements. The path length changes result in changes in the phases of the sub-components of the RF signal, thereby changing the elevation or “tilt” angle of the antenna beam.

A known type of base station antenna is a three-sector base station antenna. As shown in FIG. 1, the three-sector base station antenna 1 generally comprises three reflector assemblies 11_1, 11_2, and 11_3 in a triangular (e.g., equilateral triangle) arrangement. The three reflector assemblies 11_1, 11_2, and 11_3 may be housed in a circular radome 10, for example. The three reflector assemblies may each comprises a back plate, linear arrays of radiating elements 12_1, 12_2, and 12_3 mounted on a first face of the back plate facing outwards (i.e., toward a circumference of the radome 10), and one or more phase shifters or phase shifter assemblies (not shown in FIG. 1) mounted on a second face opposite to the first face of the back plate facing inwards (i.e., toward a center of the radome 10). The back plates of the three reflector assemblies 11_1, 11_2, and 11_3 may define a triangular (e.g., equilateral triangle) interior space 13. In the three-sector base station antenna 1 shown in FIG. 1, the one or more phase shifters or phase shifter assemblies are generally arranged on the back plates in a central symmetry mode.

In some cases, each reflector assembly of the three-sector base station antenna comprises multiple linear arrays of radiating elements, and each linear array has an electronically adjustable “tilt” angle. As a result, each reflector assembly requires multiple phase shifters to adjust the “tilt” angle of each linear array of radiating elements. However, as shown in FIG. 1, because the interior space 13 defined by the back plates of the three reflector assemblies is very small, there are numerous challenges in arranging multiple phase shifters in the interior space 13 on the back plate of each reflector assembly.

For example, as shown in FIG. 2, there is a phase shifter assembly (referred to here as “first phase shifter assembly 2”) that integrates four phase shifters. In the first phase shifter assembly 2, the four phase shifters 20 are arranged along a straight line L2 in such a mode that every two of the four phase shifters are opposite to each other and rotation centers of rotatable elements (e.g., brush plates) of the four phase shifters are aligned with each other. Such first phase shifter assembly 2 has a greater width W2 (e.g., greater than a width W1 of each transmitter assembly shown in FIG. 1), making it impossible to be arranged in the interior space 13 of the three-sector base station antenna. Therefore, the first phase shifter assembly 2 cannot be used on the three-sector base station antenna.

As shown in FIG. 3a, there is also a phase shifter assembly (referred to here as “second phase shifter assembly 3” or “V-type phase shifter assembly”) that integrates two phase shifters. Compared to the first phase shifter assembly 2, the second phase shifter assembly 3 has a smaller width W3, allowing it to be arranged on each transmitter assembly within the interior space 13 of the three-sector base station antenna. However, since each second phase shifter assembly 3 integrates only two phase shifters, two second phase shifter assemblies 3 are required to achieve the same function as each first phase shifter assembly 2. These two second phase shifter assemblies 3 cannot be arranged side by side on each transmitter assembly along a direction of the width W1 of each transmitter assembly, but are typically arranged along a direction of a height H1 of the transmitter assembly (as shown in FIG. 3b). Such arrangement can cause wiring difficulties and can reduce the gain of the base station antenna because the cable length is not optimal.

In addition, FIG. 3c and FIG. 3d also illustrate another phase shifter assembly (referred to herein as “third phase shifter assembly 4” or “SS-type phase shifter assembly”) that integrates two phase shifters and its arrangement mode in the three-sector base station antenna. The third phase shifter assembly 4 has the same problem as the second phase shifter assembly 3 shown in FIG. 3a.

In addition, the traditional symmetrical arrangement mode as shown in FIG. 1 also makes it more difficult to arrange multiple phase shifters because each phase shifter has a certain thickness, which prevents the aligned ends of the two phase shifters from being fully inserted into the narrow corners of the triangular interior space 13 when arranged symmetrically, thereby wasting the available space.

Accordingly, there is a need for improvements to existing phase shifter assemblies and/or improvements to the arrangement of the phase shifter assemblies within the three-sector base station antenna.

### SUMMARY

One of the objectives of the present disclosure is to overcome at least one shortcoming in the prior art.

In a first aspect of the present disclosure, a three-sector base station antenna is provided. The antenna includes three reflector assemblies in a triangular arrangement. Each reflector assembly includes a back plate, an array of radiating elements mounted on a first face of the back plate facing outwards, and a first phase shifter assembly mounted on a second face opposite to the first face of the back plate facing inwards. The back plate of each reflector assembly has a first central axis equally dividing a width of the back plate, and a first phase shifter assembly of each reflector assembly has a second central axis equally dividing a width of the first phase shifter assembly. The second central axis of the first phase shifter assembly of each reflector assembly is offset from the first central axis of the back plate of the reflector assembly by a predetermined distance. The first phase shifter assemblies of the three reflector assemblies of the three-sector base station antenna according to the present disclosure are arranged in a more compact mode, thereby being capable of better adapting to a narrow mounting space within the three-sector base station antenna. In addition, such arrangement mode also enables the use of more types or wider existing phase shifter assemblies in the three-sector base station antenna.

In a second aspect of the present disclosure, a three-sector base station antenna is provided. The antenna includes three reflector assemblies arranged in a triangular arrangement. Each reflector assembly includes a back plate, an array of radiating elements mounted on a first face of the back plate facing outwards, and a first phase shifter assembly mounted on a second face opposite to the first face of the back plate facing inwards. When viewed from a position above the three-sector base station antenna, an imaginary extension portion of a first end of a first phase shifter assembly of a first reflector assembly of the three reflector assemblies in a width direction of the first reflector assembly would intersect with a first phase shifter assembly of a second reflector assembly of the three reflector assemblies, while an imaginary extension portion of a second end opposite to the first end of the first phase shifter assembly of the first reflector assembly of the three reflector assemblies in the width direction of the first reflector assembly would not intersect with a first phase shifter assembly of a third reflector assembly of the three reflector assemblies. The first phase shifter assemblies of the three reflector assemblies of the three-sector base station antenna according to the present disclosure are arranged in a more compact mode, thereby being capable of better adapting to a narrow mounting space within the three-sector base station antenna. In addition, such arrangement mode also enables the use of more types or wider existing phase shifter assemblies in the three-sector base station antenna.

According to some embodiments of the present disclosure, the first phase shifter assembly includes four phase shifters which are divided into two pairs, and a connecting line of rotation centers of rotatable elements of the two phase shifters in each pair of phase shifters is tilted relative to the width direction or height direction of the first phase shifter assembly. Such first phase shifter assembly has a smaller width than an existing phase shifter assembly comprising four phase shifters, thereby enabling it to be applied to the three-sector base station antenna.

According to some embodiments of the present disclosure, the rotatable element includes a brush plate and a brush plate support member, the brush plate support member is fan-shaped, and an arc-shaped top surface of the brush plate support member comprises teeth; and teeth of brush plate support members of two phase shifters in each pair of phase shifters are engaged with each other.

According to some embodiments of the present disclosure, one of each pair of phase shifters also includes a driven member, the driven member is fixedly connected to the brush plate support member and includes a protrusion. The protrusion is matched with a groove of a drive element fixed on a drive linkage to drive the brush plate support member and the brush plate to rotate when the drive element moves along a straight line.

According to some embodiments of the present disclosure, each reflector assembly includes two first phase shifter assemblies that are arranged in a stacked configuration.

According to some embodiments of the present disclosure, the two first phase shifter assemblies are driven by a shared drive linkage.

According to some embodiments of the present disclosure, the first phase shifter assembly includes an integrated printed circuit board for the four phase shifters.

According to some embodiments of the present disclosure, the integrated printed circuit board is mounted on a metal plate, with a gap of at least 1 millimeter between the integrated printed circuit board and the metal plate.

According to some embodiments of the present disclosure, each reflector assembly further includes a second phase shifter assembly mounted on the second face opposite to the first face of the back plate facing inwards, and the second phase shifter assembly includes two phase shifters.

According to some embodiments of the present disclosure, each phase shifter of the second phase shifter assembly includes a brush plate and a brush plate support member.

According to some embodiments of the present disclosure, each reflector assembly includes two second phase shifter assemblies that are arranged in a stacked configuration.

According to some embodiments of the present disclosure, the two second phase shifter assemblies are driven by a shared drive linkage.

According to some embodiments of the present disclosure, the two second phase shifter assemblies includes a shared driven member, the shared driven member is configured as a pin shaft that is capable of driving the brush plate support members and brush plates of aligned phase shifters in the two second phase shifter assemblies in the stacked configuration.

According to some embodiments of the present disclosure, the pin shaft is matched with the groove of the drive element fixed on the drive linkage to drive the brush plate support members and the brush plates to rotate when the drive element moves along a straight line.

According to some embodiments of the present disclosure, the second phase shifter assembly of each reflector assembly has a third central axis that evenly divides a width of the second phase shifter assembly; and the third central axis of the second phase shifter assembly of each reflector assembly is offset from the first central axis of the back plate of the reflector assembly by a predetermined distance.

According to some embodiments of the present disclosure, when viewed from a position above the three-sector base station antenna, an imaginary extension portion of a first end of a second phase shifter assembly of the first reflector assembly of the three reflector assemblies in the width direction of the first reflector assembly intersects the second phase shifter assembly of the second reflector assembly of the three reflector assemblies, while an imaginary extension portion of a second end opposite to the first end of the second phase shifter assembly of the first reflector assembly of the three reflector assemblies in the width direction of the first reflector assembly does not intersect the second phase shifter assembly of the third reflector assembly of the three reflector assemblies.

According to some embodiments of the present disclosure, the three reflector assemblies are arranged in a circular radome.

It should be noted that various aspects of the present disclosure described for one example may be comprised in other different examples, even though specific description is not made for the other different examples. In other words, all the examples and/or features of any example may be combined in any mode and/or combination, as long as they are not contradictory to each other

### BRIEF DESCRIPTION OF THE DRAWINGS

A plurality of aspects of the present disclosure will be better understood after reading the following specific embodiments with reference to the attached drawings. Among the attached drawings:

FIG. 1 is a schematic top view of a three-sector base station antenna in the prior art;

FIG. 2 is a schematic diagram of a first phase shifter assembly that integrates four phase shifters in the prior art;

FIG. 3a is a schematic diagram of a second phase shifter assembly that integrates two phase shifters in the prior art;

FIG. 3b is a schematic diagram of an arrangement of a second phase shifter assembly in the three-sector base station antenna shown in FIG. 3a;

FIG. 3c is a schematic view of a third phase shifter assembly that integrates two phase shifters in the prior art;

FIG. 3d is a schematic diagram of an arrangement of a third phase shifter assembly in the three-sector base station antenna shown in FIG. 3c;

FIG. 4a is a schematic view of a three-sector base station antenna according to some embodiments of the present disclosure and its layout;

FIG. 4b is a schematic layout view of multiple phase shifter assemblies on one reflector assembly of the three-sector base station antenna shown in FIG. 4a;

FIG. 4c is a partial enlarged view of FIG. 4b;

FIG. 5a is a front view of a phase shifter assembly that integrates four phase shifters according to some embodiments of the present disclosure;

FIG. 5b is a rear view of the phase shifter assembly shown in FIG. 5a;

FIG. 6a is a front view of a phase shifter assembly that integrates four phase shifters according to some other examples of the present disclosure;

FIG. 6b is a rear view of the phase shifter assembly shown in FIG. 6a;

FIG. 7 is a schematic view of a linkage and a drive member for driving the phase shifter assembly shown in FIG. 5a to FIG. 6b according to some embodiments of the present disclosure;

FIG. 8 is a schematic view of the linkage and the drive member for driving the phase shifter assembly shown in FIG. 5a to FIG. 6b according to some other examples of the present disclosure;

FIG. 9 is a width comparison view of a phase shifter assembly that integrates four phase shifters according to the present disclosure and a first phase shifter assembly that integrates four phase shifters in the prior art;

FIG. 10 is a schematic top view of two phase shifter assemblies in a stacked configuration as shown in FIG. 5a to FIG. 6b;

FIG. 11a is a schematic front view of the two phase shifter assemblies in the stacked configuration shown in FIG. 10;

FIG. 11b is a partial enlarged view of the two phase shifter assemblies in the stacked configuration shown in FIG. 11a;

FIG. 11c is a cross-sectional view taken along line A-A in FIG. 10;

FIG. 11d is a cross-sectional view taken along line B-B in FIG. 10;

FIG. 12 is a schematic top view of the two phase shifter assemblies in the stacked configuration shown in FIG. 3a;

FIG. 13a is a schematic front view of the two phase shifter assemblies in the stacked configuration shown in FIG. 12; and

FIG. 13b is a cross-sectional view taken along line F-F in FIG. 12.

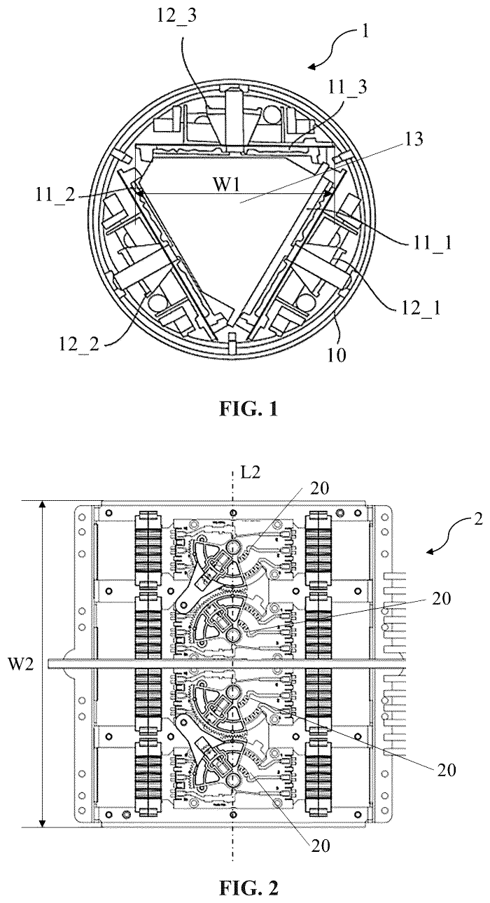

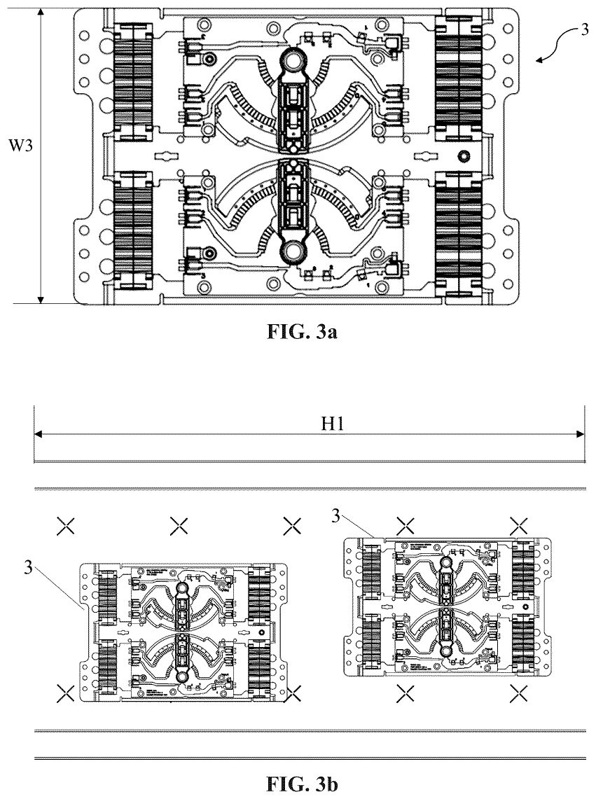

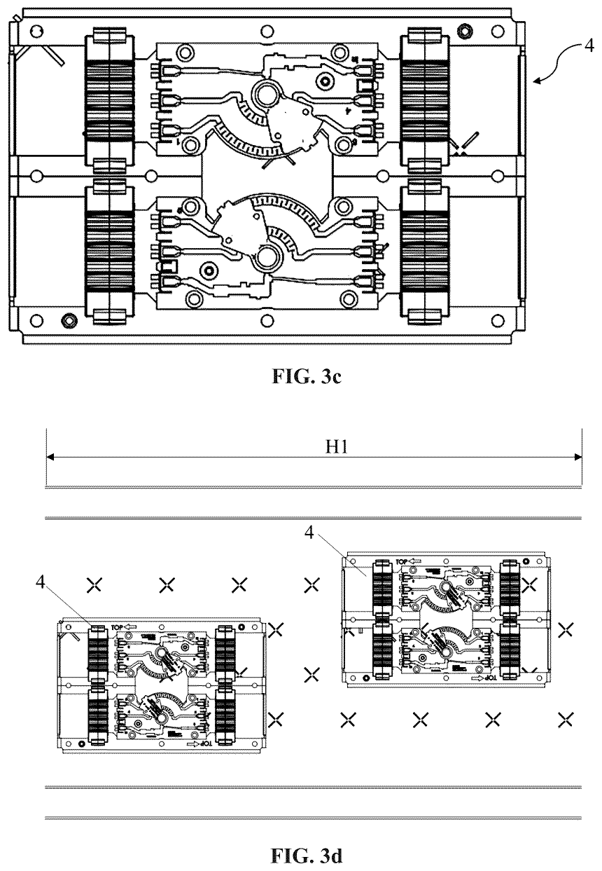

It should be understood that in all the attached drawings, the same symbols denote the same elements. In the attached drawings, for clarity, the size of certain feature is not drawn to scale as it may change.

### DETAILED DESCRIPTION

The present disclosure will be described below with reference to the attached drawings, and the attached drawings illustrate certain examples of the present disclosure. However, it should be understood that the present disclosure may be presented in many different ways and is not limited to the examples described below; in fact, the examples described below are intended to make the content of the present disclosure more complete and to fully explain the protection scope of the present disclosure to those skilled in the art. It should also be understood that the examples disclosed in the present disclosure may be combined in various ways so as to provide more additional examples.

It should be understood that the words in the Specification are only used to describe specific examples and are not intended to limit the present disclosure. Unless otherwise defined, all terms (including technical terms and scientific terms) used in the Specification have the meanings commonly understood by those skilled in the art. For brevity and/or clarity, well-known functions or structures may not be further described in detail.

The singular forms “a”, “an”, “the” and “this” used in the Specification all comprise plural forms unless clearly indicated. The words “comprise”, “contain” and “have” used in the Specification indicate the presence of the claimed features, but do not exclude the presence of one or more of other features. The word “and/or” used in the Specification comprises any or all combinations of one or more of the related listed items.

In the Specification, when it is described that an element is “on” another element, “attached” to another element, “connected” to another element, “coupled” with another element, or “in contact with” another element, etc., the element may be directly on another element, attached to another element, connected to another element, coupled with another element, or in contact with another element, or an intermediate element may be present.

In the Specification, the terms “first”, “second”, “third”, etc. are only used for convenience of description and are not intended for limitation. Any technical features represented by “first”, “second”, “third”, etc. are interchangeable.

In the Specification, terms expressing spatial relations such as “upper”, “lower”, “front”, “rear”, “top”, and “bottom” may describe the relation between one feature and another feature in the attached drawings. It should be understood that, in addition to the positions shown in the attached drawings, the words expressing spatial relations further comprise different positions of a device in use or operation. For example, when the device in the attached drawings is inverted, a feature originally described as “below” another feature may then be described as “above” the other feature. The apparatus may also be oriented in other ways (rotated 90 degrees or in other orientations), and the relative spatial relationships will be interpreted accordingly in those cases.

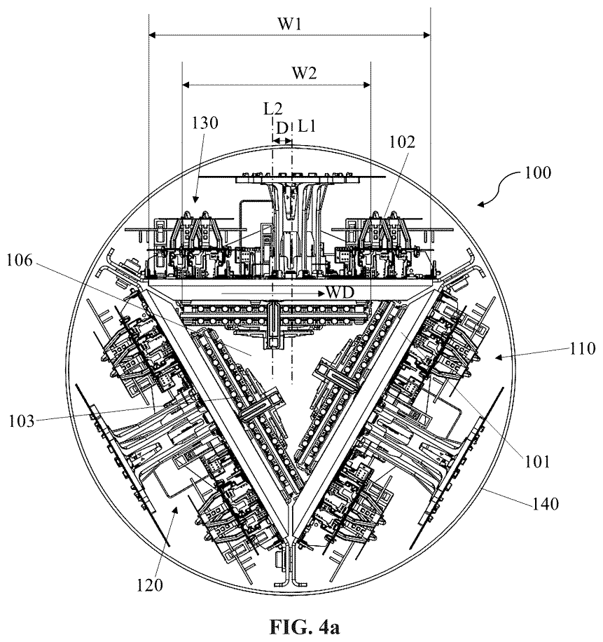

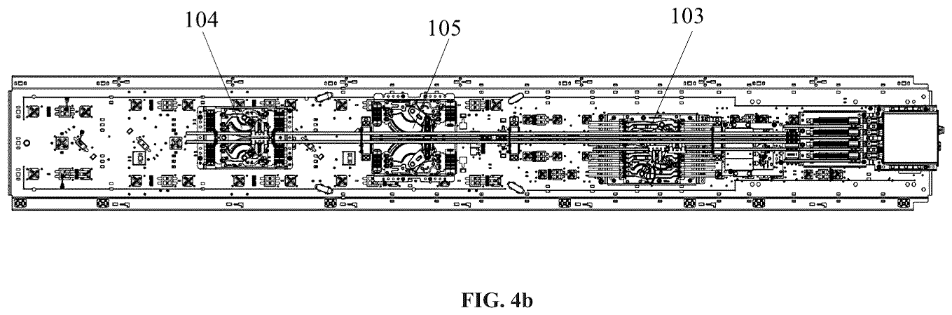

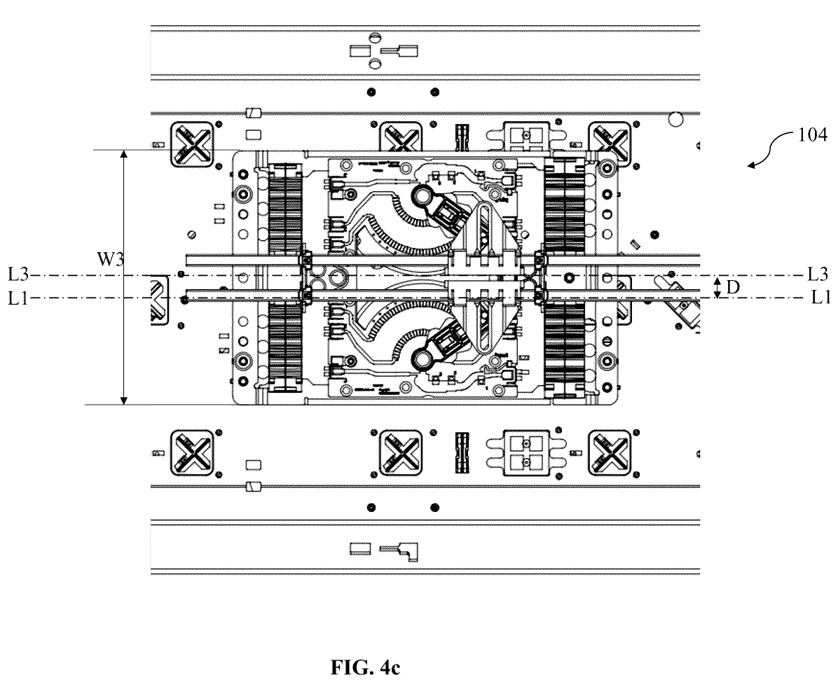

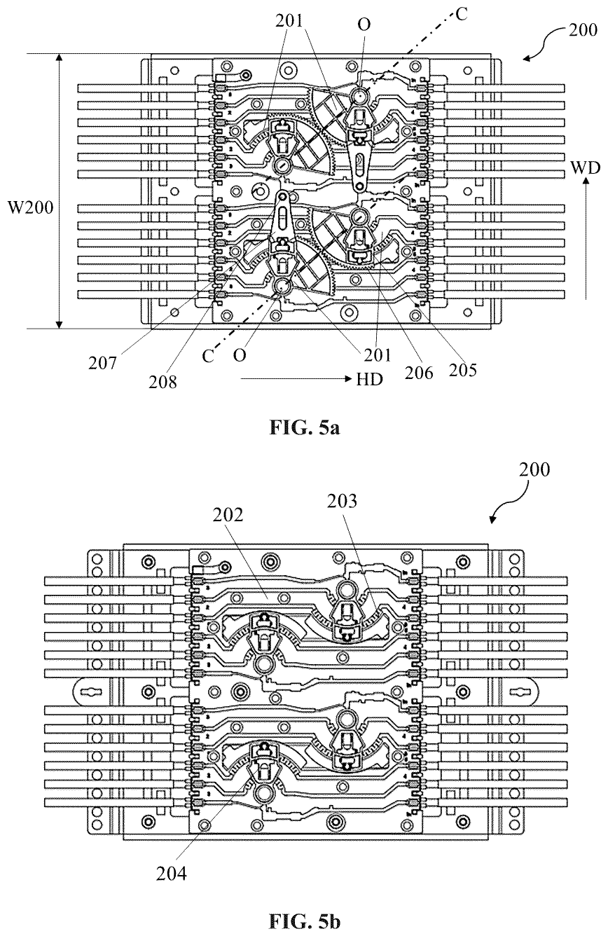

First, referring to FIG. 4a, a three-sector base station antenna 100 according to some embodiments of the present disclosure will be described. The three-sector base station antenna 100 may comprise three reflector assemblies 110, 120, and 130 in a generally triangular arrangement. The three reflector assemblies 110, 120, and 130 may be arranged in a circular radome 140. Each reflector assembly may comprise a back plate 101, an array of radiating elements 102 mounted on a first face of the back plate 101 facing outwards (i.e., toward a radome 140), and at least one phase shifter assembly mounted on a second face opposite to the first face of the back plate 101 facing inwards. In the example shown in FIG. 4a, only the first phase shifter assembly 103 is shown, while other phase shifter assemblies (e.g., a second phase shifter assembly 104 and a fifth phase shifter assembly 105) are also shown in FIG. 4b. The first phase shifter assembly 103, the second phase shifter assembly 104, and the fifth phase shifter assembly 105 may be any existing phase shifter assembly, may be the phase shifter assembly according to the present disclosure illustrated later with reference to FIG. 5a to FIG. 8, or may be any suitable phase shifter assembly that will be newly designed in future.

As shown in FIG. 4a, the back plates 101 of the three reflector assemblies 110, 120, and 130 define a generally triangular interior space 106. The phase shifter assemblies are all mounted in the interior space 106. Since the triangular interior space 106 is relatively narrow, in order to arrange multiple phase shifter assemblies (e.g., at least three first phase shifter assemblies 103) in the small interior space, the following arrangement mode is employed in one example according to the present disclosure: It is set that the back plate 101 of each reflector assembly has a first central axis L1 evenly dividing the width W1 of the back plate, and it is set that the first phase shifter assembly 103 of each reflector assembly has a second central axis L2 evenly dividing the width W2 of the first phase shifter assembly 103, when arranged, the second central axis L2 of the first phase shifter assembly 103 of each reflector assembly is offset from the first central axis L1 of the back plate 101 of the reflector assembly by a predetermined distance D. The above arrangement mode can also be described as: When viewed from a position above the three-sector base station antenna 100 (as shown in FIG. 4a), an imaginary extension portion of a first end of the first phase shifter assembly of the first reflector assembly of the three reflector assemblies in the width direction WD of the first reflector assembly intersects the first phase shifter assembly of the second reflector assembly of the three reflector assemblies, while an imaginary extension portion of a second end opposite to the first end of the first phase shifter assembly of the first reflector assembly of the three reflector assemblies in the width direction of the first reflector assembly does not intersect a first phase shifter assembly of a third reflector assembly of the three reflector assemblies.

Compared to a traditional mode that the first phase shifter assembly 103 of each reflector assembly is arranged in a central symmetry mode with respect to the back plate 101 of the reflector assembly (i.e., the second central axis L2 of the first phase shifter assembly 103 of each reflector assembly is aligned or coincided with the first central axis L1 of the back plate 101 of the reflector assembly), the arrangement mode of the present disclosure allows for a more compact configuration of the first phase shifter assemblies 103 of the three reflector assemblies, thereby being capable of better adapting to a narrow mounting space of the three-sector base station antenna 100 (i.e., the interior space 106). An advantage of the arrangement mode of the present disclosure is that it makes full use of the corner space of the triangular interior space 106, thereby making it possible to use a wider phase shifter assembly in a three-sector base station antenna. Specifically, because the phase shifter assembly (e.g., the first phase shifter assembly 103) typically has a certain thickness, if arranged in a traditional central symmetry mode, the ends of the two first phase shifter assemblies 103 would align with each other and require more space for placement. However, in the arrangement mode of the present disclosure, the ends of the two first phase shifter assemblies 103 are offset by a distance and no longer align with each other, this allows the end of each first phase shifter assembly 103 to extend deeper into one of the three corner spaces of the triangular interior space 106, thereby avoiding waste of the interior space and making it possible to use wider phase shifter assemblies in the three-sector base station antenna.

Referring to FIG. 4b and FIG. 4c, in some embodiments according to the present disclosure, each reflector assembly can comprise multiple phase shifter assemblies (for example, the first phase shifter assembly 103, the second phase shifter assembly 104, and the third phase shifter assembly 105 are arranged simultaneously on the reflector assembly shown in FIG. 4b). Each of the various phase shifter assemblies (e.g., the second phase shifter assembly 104 and/or the third phase shifter assembly 105) can be arranged with reference to the arrangement mode of the first reflector assemblies 103 as described earlier. As shown in FIG. 4c, if it is set that the second phase shifter assembly 104 has a third central axis L3 equally dividing the width W3 of the second phase shifter assembly 104, during arrangement, the third central axis L3 of each second phase shifter assembly 104 of each reflector assembly can also be made to be offset from the first central axis L1 of the back plate 101 of the reflector assembly by a predetermined distance D, which will not be elaborated on further here.

Next, referring to FIG. 5a to FIG. 9, in some embodiments according to the present disclosure, a narrower phase shifter assembly 200 that can be applied in the three-sector base station antenna is provided. The phase shifter assembly 200 according to the present disclosure can be used as, for example, the first phase shifter assembly 103, the second phase shifter assembly 104, and/or the third phase shifter assembly 105 mentioned earlier.

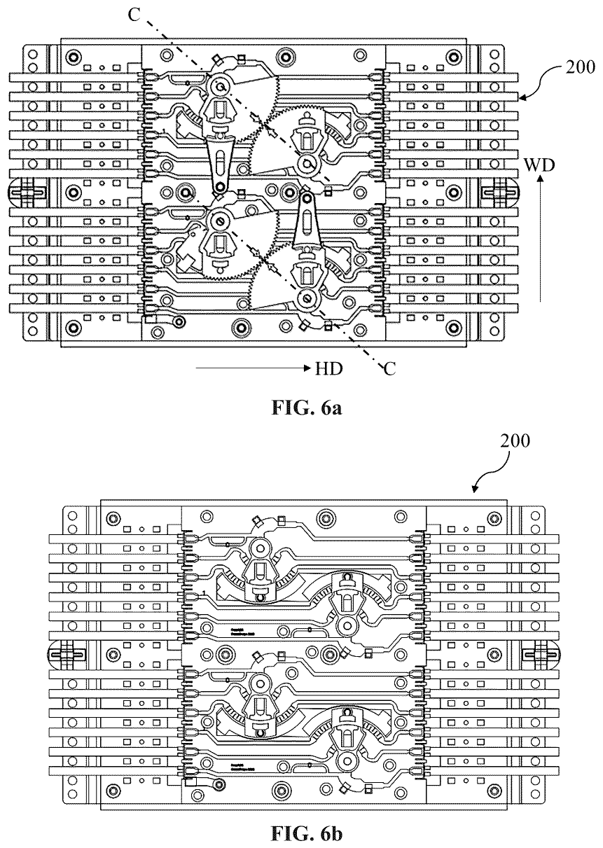

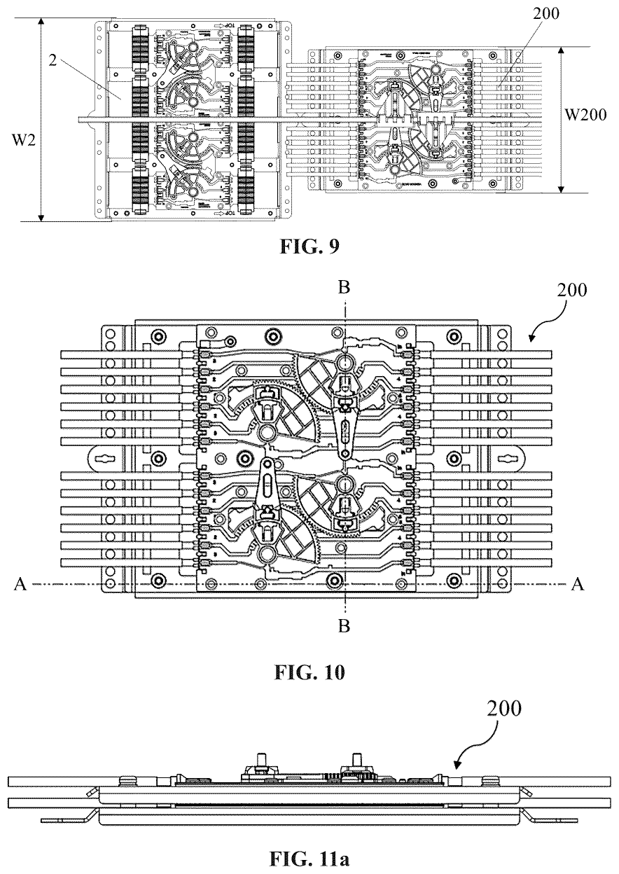

The phase shifter assembly 200 may comprise four phase shifters 201. Unlike the phase shifter assembly 2 comprising four phase shifters in the prior art shown in FIG. 2, in the phase shifter assembly 200 according to the present disclosure, the four phase shifters 201 are divided into two pairs, a connecting line C of rotation centers O of rotatable elements of the two phase shifters 201 in each pair of phase shifters is tilted relative to the width direction WD or height direction HD of the phase shifter assembly 200. The connecting line C can have different tilt directions. For example, in the example shown in FIG. 5a, the connecting line C tilts upwards along a direction from left to right, while in the example shown in FIG. 6a, the connecting line C tilts downwards along a direction from left to right. Compared to the phase shifter assembly 2 shown in FIG. 2, the phase shifter assembly 200 according to the present disclosure has a smaller width W200 due to the tilted arrangement of each pair of phase shifters 201, which can be seen more clearly in FIG. 9. The left side of FIG. 9 shows the phase shifter assembly 2 in the prior art, with a width W2 of 216 mm; and the right side of FIG. 9 shows the phase shifter assembly 200 according to the present disclosure, with a width W200 of only 160 mm, representing a width reduction of about 26%.

Continuing to refer to FIG. 5a to FIG. 6b, the phase shifter assembly 200 according to the present disclosure may comprise an integrated printed circuit board 202 for four phase shifters 201. The integrated printed circuit board 202 is provided with multiple pairs of arc-shaped transmission line tracks 203 for each phase shifter 201, respectively. Each phase shifter 201 comprises a movable element. The movable element may comprise a brush plate 204 and a brush plate support member 205. The brush plate 204 may be connected to the brush plate support member 205 and rotate under the driving of the brush plate support member 205 to slide on the corresponding arc-shaped transmission line track 203 to adjust the “tilt” angle of the linear array of radiating elements. In the example shown in FIG. 5a to FIG. 6b, the brush plate support member 205 is fan-shaped, and the arc-shaped top surface of the brush plate support member comprises teeth 206. The teeth 206 of the brush plate support member 205 of the two phase shifters 201 in each pair of phase shifters are engaged with each other, allowing only one brush plate support member 205 of one phase shifter 201 in each pair of phase shifters to be driven to rotate, while the brush plate support member of the other phase shifter will rotate following the rotation of the driven brush plate support member.

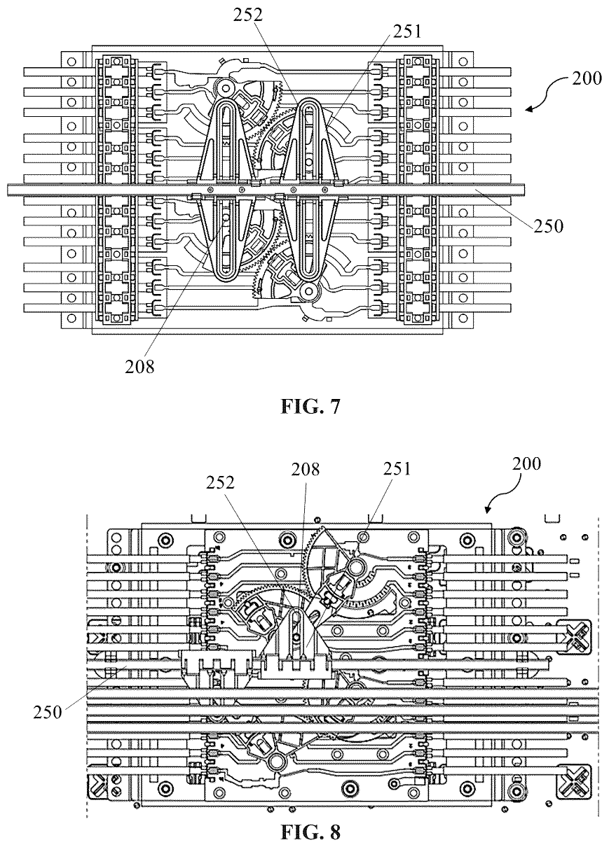

To drive the rotation of the brush plate support member 205 in each pair of phase shifters, in some embodiments, one of the phase shifters 201 in each pair of phase shifters also comprises a driven member 207. The driven member 207 may be fixedly connected to the brush plate support member 205 and may comprise a protrusion 208 (see FIG. 7 and FIG. 8). The protrusion 208 may be, for example, a cylinder, rod, pin shaft, etc. As shown in FIG. 7 and FIG. 8, the protrusion 208 may be matched with a groove 252 of a drive element 251 fixed on the drive linkage 250 (e.g., slide within the groove 252) to drive the brush plate support member 205 and the brush plate 204 to rotate when the drive element 251 moves along a straight line (e.g., move left or right with the drive linkage 250). FIG. 7 and FIG. 8 show two drive elements 251 with different configurations, respectively.

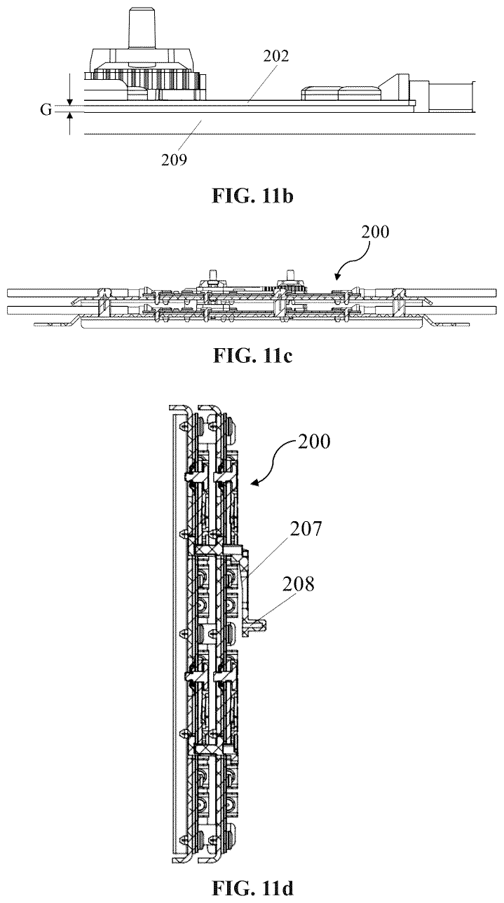

Next, referring to FIG. 10 to FIG. 11d, in some embodiments of the present disclosure, each reflector assembly may comprise two or more phase shifter assemblies 200. The two or more phase shifter assemblies 200 may be arranged in a stacked configuration to save occupied space. Arranging two or more phase shifter assemblies 200 in a stacked configuration may also make wiring easier compared to arranging the phase shifter assemblies in a tiled configuration in the prior art. Additionally, arranging two or more phase shifter assemblies 200 in a stacked configuration allows for the use of shorter cables, which is advantageous for optimizing the gain of base station antennas.

In some embodiments of the present disclosure, a common drive linkage may be used to drive the two or more phase shifter assemblies 200. This may advantageously reduce the number of components used, thereby reducing the space occupied by the phase shifter assemblies. This is beneficial in the layout of the three-sector base station antenna. In addition, traditionally, the printed circuit board of phase shifter assemblies is generally mounted on a metal plate tightly (i.e., without gaps), which makes it difficult to arrange the cables connected to the printed circuit board, because the diameters of the cables are generally larger than the thickness of the printed circuit board. Traditionally, to arrange these cables, further processing of the metal plate is required to create at least some grooves for containing the cables. In some embodiments of the present disclosure, as shown in FIG. 11b, the integrated printed circuit board 202 of the phase shifter assembly 200 is set to have a gap G of at least 1 millimeter with the metal plate 209, which eliminates the need for further machining the metal plate, thereby saving costs.

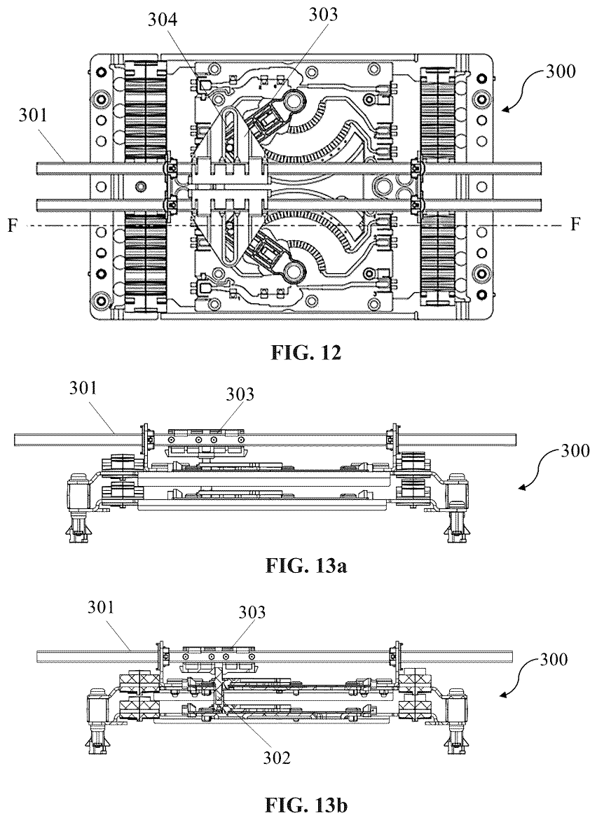

FIG. 12 to FIG. 13b show another phase shifter assembly 300 that can be used in the three-sector base station antenna according to the present disclosure. The phase shifter assembly 300 may be a phase shifter assembly that comprises two phase shifters as in the prior art. Apart from comprising only two phase shifters, the phase shifter assembly 300 may comprise the same or similar components as the phase shifter assembly 200. For example, the phase shifter assembly 300 may comprise an integrated printed circuit board, and each phase shifter may comprise a brush plate and a brush plate support member, etc., which will not be repeated here.

Referring to FIG. 13a and FIG. 13b, in some embodiments of the present disclosure, each reflector assembly may comprise two or more phase shifter assemblies 300. The two or more phase shifter assemblies 300 may be arranged in a stacked configuration to save occupied space. Similarly, arranging two or more phase shifter assemblies 300 in a stacked configuration may also make wiring easier compared to arranging the phase shifter assemblies in a tiled configuration in the prior art. Additionally, arranging two or more phase shifter assemblies 300 in a stacked configuration allows for the use of shorter cables, which is advantageous for optimizing the gain of base station antennas.

In some embodiments of the present disclosure, the two or more phase shifter assemblies 300 may be driven by a shared drive linkage 301. To this end, the two or more phase shifter assemblies 300 may comprise a shared driven member 302. As shown in FIG. 13b, the driven member 302 may be configured as a pin shaft. The pin shaft can be inserted into the brush plate support members of the aligned phase shifters in the two or more phase shifter assemblies 300 in the stacked configuration, thereby being capable of driving the brush plate support members and the brush plates of the aligned phase shifters in the two or more phase shifter assemblies 300 in the stacked configuration. Similar to the phase shifter assembly 200, the pin shaft may be matched with the groove 304 of the drive element 303 fixed on the drive linkage 301 (e.g., may slide within the groove 304) to drive the brush plate support members and the brush plates to rotate when the drive element 303 moves along a straight line (e.g., move left and right with the drive linkage 301). The use of the shared drive linkage 301 may advantageously reduce the number of components used, and thus reduce the space occupied by the phase shifter assembly, both of which are beneficial in the layout of three-sector base station antennas.

Exemplary examples according to the present disclosure have been described above with reference to the attached drawings. However, those of ordinary skill in the art should understand that various changes and modifications can be made to the exemplary examples of the present disclosure without departing from the gist and scope of the present disclosure. All changes and modifications are comprised in the protection scope of the present disclosure defined by the claims. The present disclosure is defined by the attached claims, and equivalents of these claims are also comprised.

What is claimed is:

1. A three-sector base station antenna, comprising three reflector assemblies in a triangular arrangement, wherein each reflector assembly comprises a back plate, an array of radiating elements mounted on a first face of the back plate in a mode of facing outwards, and a first phase shifter assembly mounted on a second face opposite to the first face of the back plate in a mode of facing inwards; wherein the back plate of each reflector assembly has a first central axis equally dividing a width of the back plate, the first phase shifter assembly of each reflector assembly has a second central axis equally dividing a width of the first phase shifter assembly;
and wherein the second central axis of the first phase shifter assembly of each reflector assembly is offset from the first central axis of the back plate of the reflector assembly by a predetermined distance.

2. The three-sector base station antenna according to claim 1, wherein the first phase shifter assembly comprises four phase shifters which are divided into two pairs, and a connecting line of rotation centers of rotatable elements of the two phase shifters in each pair of phase shifters is tilted relative to the width direction or height direction of the first phase shifter assembly.

3. The three-sector base station antenna according to claim 2, wherein the rotatable element comprises a brush plate and a brush plate support member, the brush plate support member is fan-shaped, and an arc-shaped top surface of the brush plate support member comprises teeth; and wherein teeth of brush plate support members of two phase shifters in each pair of phase shifters are engaged with each other.

4. The three-sector base station antenna according to claim 3, wherein one of each pair of phase shifters also comprises a driven member, the driven member is fixedly connected to the brush plate support member and comprises a protrusion, the protrusion is matched with a groove of a drive element fixed on a drive linkage to drive the brush plate support member and the brush plate to rotate when the drive element moves along a straight line.

5. The three-sector base station antenna according to claim 4, wherein each reflector assembly comprises two first phase shifter assemblies arranged in a stacked configuration.

6. The three-sector base station antenna according to claim 5, wherein the two first phase shifter assemblies are driven by a shared drive linkage.

7. The three-sector base station antenna according to claim 2, wherein the first phase shifter assembly comprises an integrated printed circuit board for the four phase shifters.

8. The three-sector base station antenna according to claim 7, wherein the integrated printed circuit board is mounted on a metal plate, with a gap of at least 1 millimeter between the integrated printed circuit board and the metal plate.

9. The three-sector base station antenna according to claim 1, wherein each reflector assembly further comprises a second phase shifter assembly mounted on the second face opposite to the first face of the back plate facing inwards, and the second phase shifter assembly comprises two phase shifters.

10. The three-sector base station antenna according to claim 9, wherein each phase shifter of the second phase shifter assembly comprises a brush plate and a brush plate support member.

11. The three-sector base station antenna according to claim 10, wherein each reflector assembly comprises two second phase shifter assemblies arranged in a stacked configuration.

12. The three-sector base station antenna according to claim 11, wherein the two second phase shifter assemblies are driven by a shared drive linkage.

13. The three-sector base station antenna according to claim 12, wherein the two second phase shifter assemblies comprise a shared driven member, the driven member is configured as a pin shaft that is capable of driving brush plate support members and brush plates of aligned phase shifters in the two second phase shifter assemblies in the stacked configuration.

14. The three-sector base station antenna according to claim 13, wherein the pin shaft is matched with the groove of the drive element fixed on the drive linkage to drive the brush plate support members and the brush plates to rotate when the drive element moves along a straight line.

15. The three-sector base station antenna according to claim 9, wherein the second phase shifter assembly of each reflector assembly has a third central axis that evenly divides a width of the second phase shifter assembly; and wherein the third central axis of the second phase shifter assembly of each reflector assembly is offset from the first central axis of the back plate of the reflector assembly by a predetermined distance.

16. The three-sector base station antenna according to claim 9, wherein when viewed from a position above the three-sector base station antenna, an imaginary extension portion of a first end of a second phase shifter assembly of the first reflector assembly of the three reflector assemblies in a width direction of the first reflector assembly intersects the second phase shifter assembly of the second reflector assembly of the three reflector assemblies, while an imaginary extension portion of a second end opposite to the first end of the second phase shifter assembly of the first reflector assembly of the three reflector assemblies in the width direction of the first reflector assembly does not intersect a second phase shifter assembly of a third reflector assembly of the three reflector assemblies.

17. The three-sector base station antenna according to claim 1, wherein the three reflector assemblies are arranged in a circular radome.

18. A three-sector base station antenna, comprising three reflector assemblies arranged in a triangular arrangement, wherein each reflector assembly comprises a back plate, an array of radiating elements mounted on a first face of the back plate facing outwards, and a first phase shifter assembly mounted on a second face opposite to the first face of the back plate facing inwards; wherein when viewed from a position above the three-sector base station antenna, an imaginary extension portion of a first end of a first phase shifter assembly of a first reflector assembly of the three reflector assemblies in a width direction of the first reflector assembly would intersect with a first phase shifter assembly of a second reflector assembly of the three reflector assemblies, while an imaginary extension portion of a second end opposite to the first end of the first phase shifter assembly of the first reflector assembly of the three reflector assemblies in the width direction of the first reflector assembly would not intersect with a first phase shifter assembly of a third reflector assembly.

19. The three-sector base station antenna according to claim 18, wherein the first phase shifter assembly comprises four phase shifters which are divided into two pairs, and a connecting line of rotation centers of rotatable elements of the two phase shifters in each pair of phase shifters is tilted relative to the width direction or height direction of the first phase shifter assembly.

20. The three-sector base station antenna according to claim 18, wherein each reflector assembly further comprises a second phase shifter assembly mounted on the second face opposite to the first face of the back plate facing inwards, and the second phase shifter assembly comprises two phase shifters.
